(19) United States
(12) Patent Application Publication
(10) Pub. No.: US 2009/0276632 A1
(43) Pub. Date: Nov. 5, 2009

(54) Systems, Methods, and Media for Providing Secure Content Information

(76) Inventors: Howard M. Singer, Morganville, NJ (US); George Lydecker, Burbank, CA (US)

Correspondence Address: Byrne Poh LLP, 11 Broadway, Ste 865, New York, NY, 10004, US

(21) Appl. No.: 12/433,487

(22) Filed: Apr. 30, 2009

Related U.S. Application Data
(60) Provisional application No. 61/049,321, filed on Apr. 30, 2008.

(51) Int. Cl. H04L 9/32; G06F 21/00

(52) U.S. Cl. 713/176; 726/26

(57) ABSTRACT

Systems, methods, and media for providing secure content information are provided. In some embodiments, systems for providing secure content information are provided, the systems comprising: a processor that creates a payload, creates a validation value, securely stores the validation value in association with a content distribution, and stores the payload in association with the content distribution. In some embodiments, systems for providing secure content information are provided, the systems comprising: a processor that receives a payload associated with a content distribution, creates a first validation value for the payload, recovers a second validation value associated with the content distribution, compares the first validation value and the second validation value, and determines if the payload has been tampered with.

### CROSS REFERENCE TO RELATED APPLICATION

This application claims the benefit of U.S. Provisional Patent Application No. 61/049,321, filed Apr. 30, 2008, which is hereby incorporated by reference herein in its entirety.

### TECHNICAL FIELD

The disclosed subject matter relates to systems, methods, and media for providing secure content information.

### BACKGROUND

Content distributions, such as music compact discs, movie digital video discs, music files, etc., frequently contain information regarding the content that is useful for tracking the content, presenting the content, etc. For example, music compact discs with explicit language may include parental advisory information that can be presented before the music is played, and/or can be used to prevent a child from listening to the music.

In many instances, such information is hidden in the content distribution in order to prevent the information from being tampered with. For example, information is sometimes hidden in a watermark in a music file. Hiding information, however, can be problematic when the information is large or when the information needs to be added at different points in the content creation and distribution process. For example, if the information is large, it may be difficult to include the information in a watermark because the watermark may impact the quality of music in the content. As another example, separate watermarks may be required if information is going to be generated at different points, such as content creation and retail sales.

### SUMMARY

Systems, methods, and media for providing secure content information are provided. In some embodiments, systems for providing secure content information are provided, the systems comprising: a processor that creates a payload, creates a validation value, securely stores the validation value in association with a content distribution, and stores the payload in association with the content distribution.

In some embodiments, systems for providing secure content information are provided, the systems comprising: a processor that receives a payload associated with a content distribution, creates a first validation value for the payload, recovers a second validation value associated with the content distribution, compares the first validation value and the second validation value, and determines if the payload has been tampered with.

In some embodiments, methods for providing secure content information are provided, the methods comprising: creating a payload; creating a validation value; securely storing the validation value in association with a content distribution; and storing the payload in association with the content distribution.

In some embodiments, methods for providing secure content information are provided, the methods comprising: receiving a payload associated with a content distribution; creating a first validation value for the payload; recovering a second validation value associated with the content distribution; comparing the first validation value and the second validation value; and determining if the payload has been tampered with.

In some embodiments, non-transitory computer-readable media containing computer-executable instructions that, when executed by a processor, cause the processor to perform a method for providing secure content information, are provided, the method comprising: creating a payload; creating a validation value; securely storing the validation value in association with a content distribution; and storing the payload in association with the content distribution.

In some embodiments, non-transitory computer-readable media containing computer-executable instructions that, when executed by a processor, cause the processor to perform a method for providing secure content information, the method comprising: receiving a payload associated with a content distribution; creating a first validation value for the payload, recovering a second validation value associated with the content distribution; comparing the first validation value and the second validation value; and determining if the payload has been tampered with.

### BRIEF DESCRIPTION OF THE DRAWINGS

FIG. 1 is a diagram of a process for creating and associating a payload with a content file in accordance with some embodiments.

FIG. 2 is a diagram of a process for recovering and checking a payload from a content file in accordance with some embodiments.

FIG. 3 is a diagram of a payload in accordance with some embodiments.

FIG. 4 is a diagram of the structure of a watermark in accordance with some embodiments.

FIG. 5 is a diagram of a process for treating content based on metadata and a validation code in accordance with some embodiments.

FIG. 6 is a diagram of hardware for implementing process described herein in accordance with some embodiments.

### DETAILED DESCRIPTION

In accordance with various embodiments, mechanisms, which can include systems, methods, and/or media, for providing secure content information are provided. These mechanisms can be used in a variety of applications. For example, these mechanisms can be used to provide information regarding music and/or audio content on a compact disc. As another example, theses mechanisms can be used to provide information regarding movies and/or video content on a digital video disc.

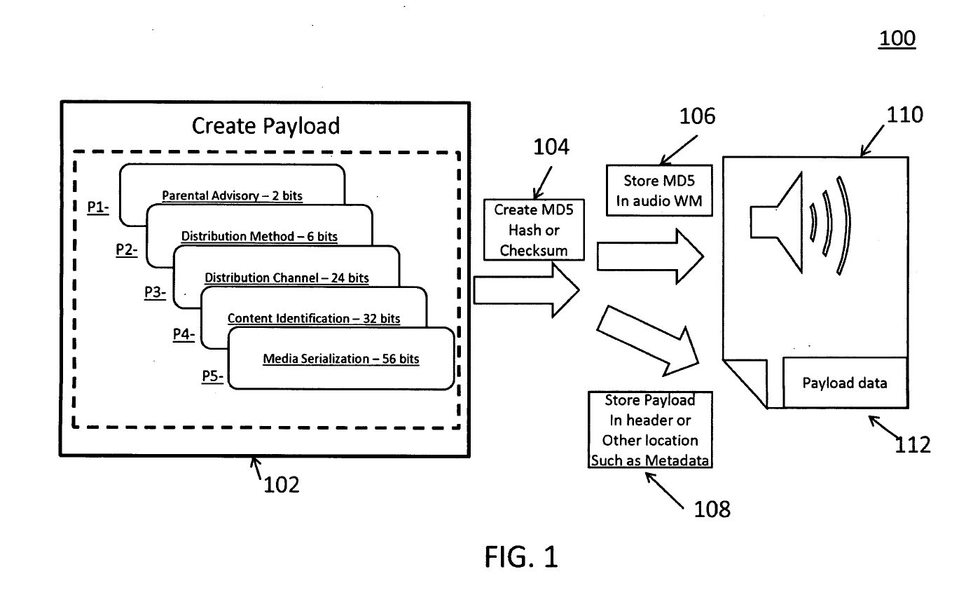

Turning to FIG. 1, a process 100 for creating and associating a payload with a content file in accordance with some embodiments is illustrated. As shown, at 102 a payload is created. This payload can contain any suitable information as desired. For example, the payload can contain information relating to content on a piece of media. As a more particular example, with a music compact disc, the payload can contain information regarding the music, such as a parental advisory, a distribution method identifier, a distribution channel identifier, a content identifier, a media serialization identifier, and/or any other suitable information.

The creation of the payload at 102 can be performed at any one or more suitable points in the content generation and distribution process. For example, a parental advisory portion of a payload can be created and associated with music content when it is produced. As another example, the creation of a parental advisory portion of a payload and the association of that portion with music content can be performed in some instances when the music content is sold to a consumer so that the parental advisory can be conformed to local custom and/or laws in which the music content is being distributed. As yet another example, a transaction number associated with the content can be added to the payload before the content is distributed to a digital service provider (such as a mobile service provider or phone service provider), when the content is sold by a retailer, etc.

Next, at 104, a validation value is created for the payload. This validation value can be created using any suitable mechanism for determining whether the payload integrity has been compromised. For example, as illustrated in FIG. 1, the validation value can be a hash formed by hashing the payload using the MD5 hashing algorithm, and/or any other suitable hashing algorithm. As another example, the validation value can be a checksum created using any suitable checksum algorithm.

The validation value is then stored in any suitable secure manner in the content at 106. For example, in some embodiments, the validation value can be stored in a secure manner so that they validation value cannot be easily found and/or easily altered. As a more particular example, as illustrated in FIG. 1, the validation value can be stored in a watermark in an audio file 110 (which can be on a compact disc, for example) defined by the content using any suitable technique. For example, commercially known techniques for placing a watermark in an audio file can be used in accordance with some embodiments.

At 108, the payload is stored in association with the content. For example, when the content is stored on a compact disc 110, the payload can be stored in a header and/or metadata 112 for the content on compact disc 110. The payload can be stored in an unencrypted and publicly known location in some embodiments. For example, storing the payload in an unencrypted form and in a public location may be tolerable from a security perspective because the validation value will indicate if the payload integrity has been compromised. While the payload is shown in FIG. 1 as being associated with the content after 104, in some embodiments, the payload can be associated with the content at any suitable point, and can be re-associated as it is updated, for example.

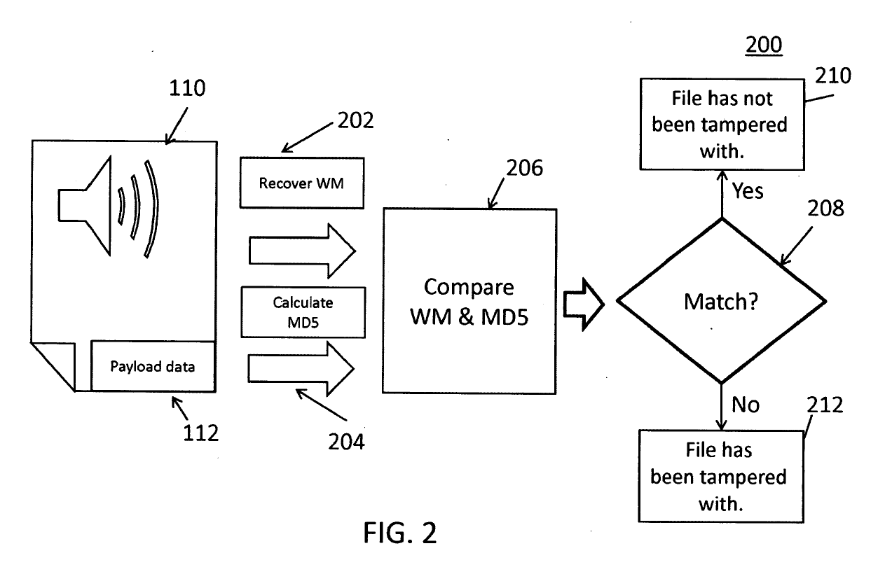

FIG. 2 illustrates an example of a process 200 for recovering a payload 112 associated with content 110 and determining whether the payload has been compromised in accordance with some embodiments. As shown, a validation value is recovered at 202. This validation value can be stored in association with the content in any suitable manner. For example, in some embodiments, the validation value can be stored in a watermark associated with the content. Next, at 204, 206, and 208, the validation value is checked to determine if the payload integrity has been compromised using any suitable technique. For example, as shown, at 204 an MD5 hash of the payload data can be calculated, the MD5 hash can then be compared at 206 against the validation value recovered at 202, and a determination can be made as to whether the MD5 hash and the validation value match at 208. If the MD5 hash and the validation value match, then process 200 determines at 210 that the file has not been tampered with. Otherwise, process 200 determines at 212 that the file has been tampered with.

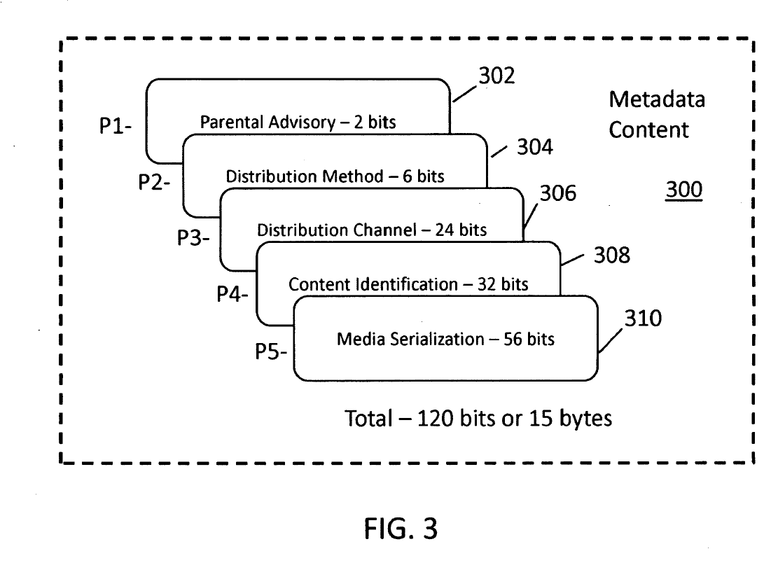

Turning to FIG. 3, an example of a payload 300 in accordance with some embodiments is illustrated. Payload 300 can be an unencrypted numerical string that represents various pieces of information. For example, as shown, payload 300 can include a parental advisory indicator 302, a distribution method indicator 304, a distribution channel indicator 306, a content identifier 308, and a media serialization indicator 310. Parental advisory indicator 302 can be any suitable indicator regarding the suitability of content for children and can be 2 bits long in some embodiments. For example, parental advisory indicator 302 can indicate that content has graphic language in accordance with some embodiments. Distribution method indicator 304 can be any suitable indicator regarding the distribution method of the content associated with the payload and can be 6 bits long in some embodiments. For example, the distribution method indicator can indicate that the content was distributed on compact disc in some embodiments. Distribution channel indicator 306 can be any suitable indicator regarding the channels of distribution used to distribute the content associated with the payload and can be 24 bits long in some embodiments. For example, the distribution channel indicator can indicate that the content was distributed through a certain chain of physical stores in some embodiments. Content identifier 308 can be any suitable indicator regarding the content and can be 32 bits long in some embodiments. For example, the content identifier can indicate that the content is a certain musical composition by a certain artist in some embodiments. Media serialization indicator 310 can be any suitable indicator for uniquely identifying a particular content distribution and can be 56 bits long in some embodiments. For example, the media serialization indicator can indicate a unique serial number for a Blu-ray disc in some embodiments. Additionally or alternative, in some embodiments, the payload can contain a copyright assertion, a retailer identifier, a transaction number, and/or any other suitable information.

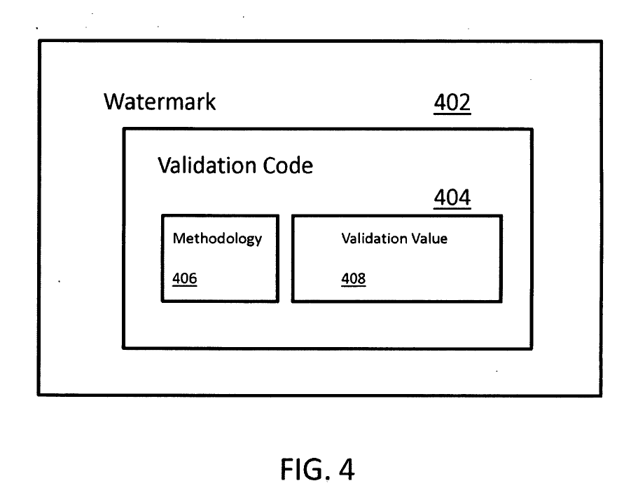

FIG. 4 illustrates an example of how a validation value 408 can be stored in a watermark 402 in accordance with some embodiments. As shown, the watermark 402 can store a validation code 404 that includes a methodology indicator 406 and validation value 408. The methodology indicator can indicate that the validation value was formed using a certain methodology, such as MD5 hashing or a checksum for example, and this indicator used when checking the integrity of the payload (for example, by being the basis for which hashing technique is used at 204 in FIG. 2). In some embodiments, the methodology indicator can be omitted (for example, when only one methodology is used), and, in some embodiments, the methodology indicator can indicate that multiple methodologies were used to create the validation value. In some embodiments, the methodology indicator can include data (such as a date, an index, etc.) which can be used to look-up a methodology indicator stored separately from the content (in a look-up table on a server, for example). Although the validation code is illustrated in FIG. 4 as being located in a watermark, in some embodiments, the validation code can be located in any suitable structure.

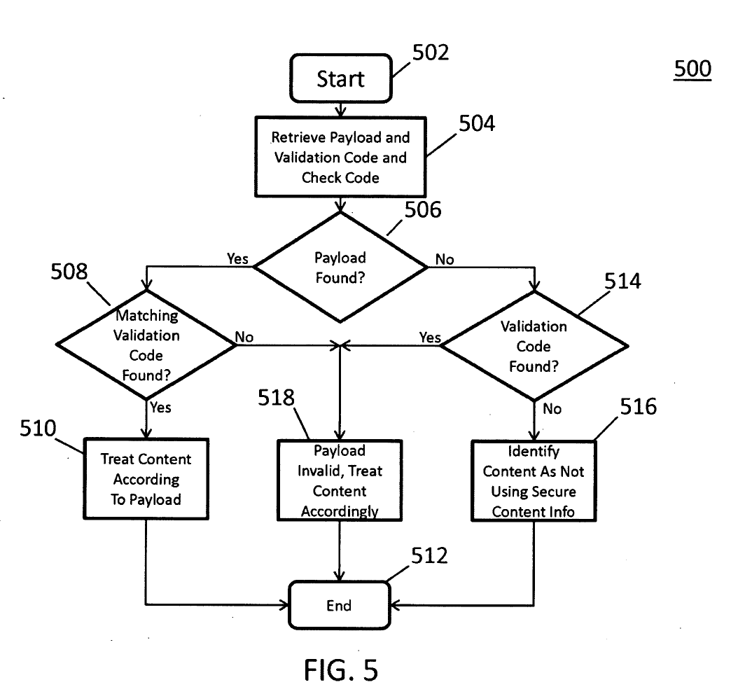

In accordance with some embodiments, content players (for example, media players such as compact disc players, etc.) can alter how content is processed based on the integrity check illustrated in FIG. 2. An example of a process 500 for how this can be done is illustrated in FIG. 5. As shown, after process 500 begins at 502, the process at 504 retrieves a payload and a validation code and checks the code using any suitable technique. For example, the code can be checked as illustrated in FIG. 2. Next, at 506, process 500 determines if a payload was found at 504. If was determined that a payload was found, process 500 determines at 508 whether a matching validation code was found. If it is determined at 508 that a matching validation code was found, then process 500 causes the content to be treated according to the payload at 510. For example, based on the content of the payload, process 500 may cause a parental advisory to be displayed on personal computer on which the content is being presented, or may cause bonus material from the content owner to be provided. If it was determined that a matching validation code was not found at 508, however, then process 500, at 518, determines that the payload is invalid causes the content to be treated accordingly. For example, process 500 may cause a user-generated content site to use a fingerprinting algorithm (rather than a content identifier contained in the content or payload) to determine how to treat the content (for example, as not to be copied). As another example, process 500 may cause bonus material to be withheld from a user because of the invalid payload. As yet another example, process 500 may cause parental controls to be applied to the content according to one or more default settings (for example, content may be blocked from being presented by default).

If, at 506, it was determined that a payload was not found, then process 500 determines at 514 whether a validation code was found. If it is determined that a validation code was found, then process 500, at 518, determines that the payload is invalid and causes the content to be treated accordingly (for example, as described above for 518). Otherwise, if it is determined at 514 that a validation code was not found, then the content is identified as not using secure content information and may be treated accordingly. For example, process 500 may cause a user-generated content site to use a fingerprinting algorithm (rather than a content identifier contained in the content or payload) to determine how to treat the content (for example, as not to be copied). As another example, process 500 may cause bonus material to be withheld from a user because of the invalid payload. As yet another example, process 500 may cause parental controls to be applied to the content according to one or more default settings (for example, content may be blocked from being presented by default).

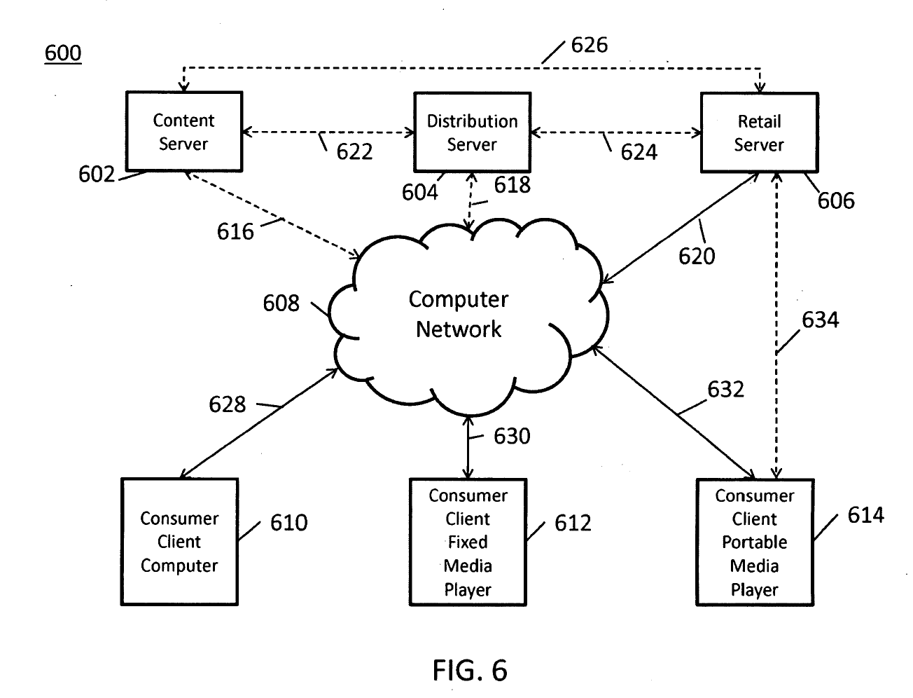

Example hardware 600 that can be used to implement the processes described above in accordance with some embodiments is described below in connection with FIG. 6. As shown, hardware 600 can include a content server 602, a distribution server 604, a retail server 606, a computer network 608, a consumer client computer 610, and consumer client fixed media player 612, and a consumer client portable media player 614. These mechanisms can be coupled using connections 616-634.

Content server 602 can be any suitable device for storing content, such as music, video, and/or data files. Although only a single content server 602 is illustrated, any suitable number of content servers 602 can be used in some embodiments. Distribution server 604 can be any suitable device for distributing content from content server 602 to a retail server 606. For example, distribution server 604 can control which retail servers have access to content on content server 602 and can track the details of the content accessed (for example, for billing purposes). Retail server 606 can be any suitable device for making content available to consumers. For example, retail server can be a web site that distributes content to end users through the Internet. As another example, retail server can be a kiosk in physical store where a user can purchase a compact disc with user-selected music thereon. Although separate content, distribution, and retail servers are illustrated, any of these can be combined in some embodiments. As illustrated, content server 602, distribution server 604, and retail server 606 can be coupled to computer network 608 by connections 616, 618, and 620, respectively. Additionally or alternatively, these servers can be coupled together by connections 622, 624, and 626 as shown.

Computer network 608 can be any suitable network, or combination of networks, for connecting computer equipment. For example, computer network 608 can include the Internet, one or more wired networks, one or more wireless networks, one or more local area networks, one or more wide area networks, one or more telephone networks, one or more 3G networks, one or more cable networks, one or more satellite networks, and/or any other suitable communication networks.

Consumer client computer 610 can be any suitable computer for accessing content. For example, computer 610 can be a personal computer running any suitable operating system. Consumer client fixed media player 612 can be any suitable non-portable device for playing media. For example, player 612 can be a compact disc player, a digital video disc player, a memory chip player, a streaming media player, a digital video recorder, a media center, a set top box, a television, etc. Consumer client portable media player 614 can be any suitable portable device for playing media. For example, player 614 can be a mobile phone, a portable music and/or video player (e.g., an MP3 player), a portable computing device (e.g., a personal digital assistant), etc. Computer 610 and players 612 and 614 can be coupled to computer network 608 using connections 628, 630, and 632. In some embodiments, player 614 can be connected to retail server 606 directly via connection 634, for example when player 614 is brought to the location of server 606.

Any of servers 602, 604, and 606, computer 610, and players 612 and 614 can include any suitable processing circuitry, memory, and interfaces for performing the processes described herein. For example, these components can include a microprocessor, a processor, a digital processing device, a controller, a programmable logic device, discrete logic, etc. for controlling the performance of the processes described herein. As another example, these components can include memory, such as random access memory, read-only memory, a disk drive (such as a hard disk, a floppy disk, etc.), optical media (such as a compact disc, a digital video disc, a Blu-ray disc, etc.), etc. for storing instructions for performing the processes described herein. As yet another example, these components can include a writeable media drive (e.g., such as an optical drive) for writing computer readable media (e.g., compact discs, digital video discs, Blu-ray discs, etc.) with content, a validation code, and a payload.

Connections 616-634 can be any suitable mechanisms for connecting the mechanisms illustrated FIG. 6. For example, these connections can be wired or wireless connections, patch cables, cable networks, television networks, telephone networks, satellite networks, 3G networks, etc.

In some embodiments, any suitable computer readable media can be used for storing instructions for performing the processes described herein, can be used as a content distribution that stores content a payload, and a validation code, etc. For example, in some embodiments, computer readable media can be transitory or non-transitory. For example, non-transitory computer readable media can include media such as magnetic media (such as hard disks, floppy disks, etc.), optical media (such as compact discs, digital video discs, Blu-ray discs, etc.), semiconductor media (such as flash memory, electrically programmable read only memory (EPROM), electrically erasable programmable read only memory (EEPROM), etc.), any suitable media that is not fleeting or devoid of any semblance of permanence during transmission, and/or any suitable tangible media. As another example, transistory computer readable media can include signals on networks, in wires, conductors, optical fibers, circuits, any suitable media that is fleeting and devoid of any semblance of permanence during transmission, and/or any suitable intangible media.

Although the invention has been described and illustrated in the foregoing illustrative embodiments, it is understood that the present disclosure has been made only by way of example, and that numerous changes in the details of implementation of the invention can be made without departing from the spirit and scope of the invention, which is only limited by the claims which follow. Features of the disclosed embodiments can be combined and rearranged in various ways.

What is claimed is:

1. A system for providing secure content information comprising:
a processor that creates a payload, creates a validation value, securely stores the validation value in association with a content distribution, and stores the payload in association with the content distribution.

2. The system of claim 1, wherein the validation value is stored in a watermark in the content distribution.

3. The system of claim 1, wherein the processor also stores a methodology used to create the validation value in association with the content distribution.

4. The system of claim 1, wherein the validation value comprises a hash of the payload.

5. The system of claim 1, wherein the validation value comprises a checksum of the payload.

6. The system of claim 1, wherein the payload is stored in metadata in the content distribution.

7. The system of claim 1, wherein the content distribution is optical media.

8. The system of claim 1, wherein the content distribution is a media file.

9. A system for providing secure content information comprising:
a processor that receives a payload associated with a content distribution, creates a first validation value for the payload, recovers a second validation value associated with the content distribution, compares the first validation value and the second validation value, and determines if the payload has been tampered with.

10. The system of claim 9, wherein the second validation value is recovered from a watermark in the content distribution.

11. The system of claim 9, wherein the processor also determines a methodology used to create the second validation value and uses the methodology to create the first validation value.

12. The system of claim 9, wherein the validation value comprises a hash of the payload.

13. The system of claim 9, wherein the validation value comprises a checksum of the payload.

14. The system of claim 9, wherein the payload is stored in metadata in the content distribution.

15. The system of claim 9, wherein the content distribution is optical media.

16. The system of claim 9, wherein the content distribution is a media file.

17. A method for providing secure content information comprising:
creating a payload;
creating a validation value;
securely storing the validation value in association with a content distribution; and
storing the payload in association with the content distribution.

18. The method of claim 17, wherein the validation value is stored in a watermark in the content distribution.

19. The method of claim 17, further comprising storing a methodology used to create the validation value in association with the content distribution.

20. The method of claim 17, wherein the validation value comprises a hash of the payload.

21. The method of claim 17, wherein the validation value comprises a checksum of the payload.

22. The method of claim 17, wherein the payload is stored in metadata in the content distribution.

23. The method of claim 17, wherein the content distribution is optical media.

24. The method of claim 17, wherein the content distribution is a media file.

25. A method for providing secure content information comprising:
receiving a payload associated with a content distribution;
creating a first validation value for the payload;
recovering a second validation value associated with the content distribution;
comparing the first validation value and the second validation value; and
determining if the payload has been tampered with.

26. The method of claim 25, wherein the second validation value is recovered from a watermark in the content distribution.

27. The method of claim 25, further comprising determining a methodology used to create the second validation value and using the methodology to create the first validation value.

28. The method of claim 25, wherein the validation value comprises a hash of the payload.

29. The method of claim 25, wherein the validation value comprises a checksum of the payload.

30. The method of claim 25, wherein the payload is stored in metadata in the content distribution.

31. The method of claim 25, wherein the content distribution is optical media.

32. The method of claim 25, wherein the content distribution is a media file.

33. A non-transitory computer-readable medium containing computer-executable instructions that, when executed by a processor, cause the processor to perform a method for providing secure content information, the method comprising:
creating a payload;
creating a validation value;
securely storing the validation value in association with a content distribution; and
storing the payload in association with the content distribution.

34. A non-transitory computer-readable medium containing computer-executable instructions that, when executed by a processor, cause the processor to perform a method for providing secure content information, the method comprising:
receiving a payload associated with a content distribution;
creating a first validation value for the payload;
recovering a second validation value associated with the content distribution;
comparing the first validation value and the second validation value; and
determining if the payload has been tampered with.
